(19) United States
(12) Patent Application Publication
(10) Pub. No.: US 2024/0428759 A1
(43) Pub. Date: Dec. 26, 2024

(54) INFORMATION PROCESSING DEVICE, ELECTRONIC MUSICAL INSTRUMENT, ELECTRONIC MUSICAL INSTRUMENT SYSTEM, AND SOUND PRODUCTION CONTROL METHOD

(71) Applicant: CASIO COMPUTER CO., LTD., Tokyo (JP)

(72) Inventors: Makoto DANJYO, Tokyo (JP); Fumiaki OTA, Tokyo (JP); Atsushi NAKAMURA, Tokyo (JP)

(73) Assignee: CASIO COMPUTER CO., LTD., Tokyo (JP)

(21) Appl. No.: 18/746,529

(22) Filed: Jun. 18, 2024

(30) Foreign Application Priority Data
Jun. 20, 2023 (JP) 2023-100418

(51) Int. Cl. G10H 1/00; G10H 1/34

(52) U.S. Cl. CPC G10H 1/0025; G10H 1/34; G10H 2250/455

(57) ABSTRACT

An information processing device configured to be installed in or in communication with an electronic musical instrument having a plurality of performance operators respectively specifying a plurality of pitches, comprising: a processor that performs the following: if an operation on a first performance operator among the plurality of performance operators is detected while no operation has been performed on any of the plurality of performance operators, and further if an operation on a second performance operator different from the first performance operator among the plurality of performance operators is detected while the operation on the first performance operator continues, causing the a sound generation section to produce sound of a pitch specified by the first performance operator and sound of a pitch specified by the second performance operator with synthesized singing voices of different singers, respectively.

### BACKGROUND OF THE INVENTION

### Technical Field

The present invention relates to an information processing device, an electronic musical instrument, an electronic musical instrument system, and a sound production control method.

### Background Art

### Related Art Document

Conventionally, there has been known a technique for producing a singing voice at a pitch corresponding to the operation on the performance operators in an electronic musical instrument. Japanese Patent Application Publication No. 2022-145465 discloses a technique in which a male singing voice is assigned to the bass range 1, a female singing voice is assigned to the treble range 2, and a singing voice that is morphed from the singing voices in range 1 and range 2 and is intermediate between the male singing voice and the female singing voice is assigned to a range 3 that is between the ranges 1 and 2. But harmony between multiple different singing voices within the same pitch range has not been achieved.

### SUMMARY OF THE INVENTION

Features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides an information processing device configured to be installed in or in communication with an electronic musical instrument having a plurality of performance operators respectively specifying a plurality of pitches, comprising: a processor that performs the following: if an operation on a first performance operator among the plurality of performance operators is detected while no operation has been performed on any of the plurality of performance operators, and further if an operation on a second performance operator different from the first performance operator among the plurality of performance operators is detected while the operation on the first performance operator continues, causing the a sound generation section to produce sound of a pitch specified by the first performance operator and sound of a pitch specified by the second performance operator with synthesized singing voices of different singers, respectively.

In another aspect, the present disclosure provides a method performed by a processor configured to be installed in or in communication with an electronic musical instrument having a plurality of performance operators respectively specifying a plurality of pitches, the method comprising: if an operation on a first performance operator among the plurality of performance operators is detected while no operation has been performed on any of the plurality of performance operators, and further if an operation on a second performance operator different from the first performance operator among the plurality of performance operators is detected while the operation on the first performance operator continues, causing the a sound generation section to produce sound of a pitch specified by the first performance operator and sound of a pitch specified by the second performance operator with synthesized singing voices of different singers, respectively.

In another aspect, the present disclosure provides a non-transitory computer readable storage medium storing instructions executable by a processor that is configured to be installed in or in communication with an electronic musical instrument having a plurality of performance operators respectively specifying a plurality of pitches, the instruction causing the processor to perform the following: if an operation on a first performance operator among the plurality of performance operators is detected while no operation has been performed on any of the plurality of performance operators, and further if an operation on a second performance operator different from the first performance operator among the plurality of performance operators is detected while the operation on the first performance operator continues, causing the a sound generation section to produce sound of a pitch specified by the first performance operator and sound of a pitch specified by the second performance operator with synthesized singing voices of different singers, respectively.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is a diagram showing an example of the overall configuration of an electronic musical instrument system according to the present invention.

FIG. 2 is a diagram showing the appearance of the electronic musical instrument shown in FIG. 1.

FIG. 3 is a block diagram showing the functional configuration of the electronic musical instrument shown in FIG. 1.

FIG. 4 is a block diagram showing the functional configuration of the terminal device in FIG. 1.

FIG. 5 is a diagram illustrating a configuration related to the generation of a singing voice in response to key press operations on the keyboard in the singing voice production mode of the electronic musical instrument of FIG. 1.

FIG. 6 is a flowchart showing the flow of key press/key release event processing executed by the CPU of FIG. 3.

FIG. 7 is a flowchart showing the flow of buffer processing executed by the CPU of FIG. 3.

FIG. 8 is a flowchart showing the flow of key press process A executed by the CPU of FIG. 3.

FIG. 9 is a flowchart showing the flow of key press process B executed by the CPU of FIG. 3.

FIG. 10 is a flowchart showing the flow of key press process C executed by the CPU of FIG. 3.

### DETAILED DESCRIPTION OF EMBODIMENTS

According to the present disclosure, when a plurality of performance operators are operated at the same time on an electronic musical instrument, harmony with a plurality of singing voices can be realized even if the operated performance operators are within the same pitch range.

Embodiments of the invention will be described with reference to drawings.

The embodiments described below are subject to various technically preferable limitations for implementing the present invention. Therefore, the technical scope of the present invention is not limited to the following embodiments and illustrated examples.

For example, in these embodiments, it is expressed as a “singing voice” for convenience, but the “singing voice” in the present invention includes “voice” and “sound” that are not singing.

Furthermore, “singers” include not only humans but also other living things and computers that output audio.

### <Configuration of Electronic Musical Instrument System 1>

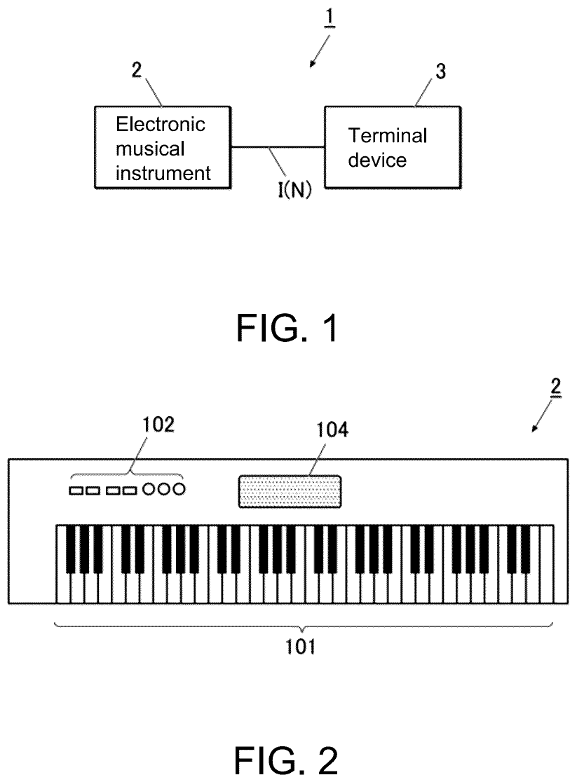

FIG. 1 is a diagram showing an example of the overall configuration of an electronic musical instrument system 1 according to the present invention. As shown in FIG. 1, the electronic musical instrument system 1 includes an electronic musical instrument 2 and a terminal device 3 connected via a communication interface I (or communication network N).

### <Configuration of Electronic Musical Instrument 2>

The electronic musical instrument 2 has a normal mode in which musical instrument sounds are output in response to the user's key depressions on the keyboard 101, and a singing voice production mode in which a singing voice is produced in response to the key depressions in the keyboard 101. Basically, in the singing voice production mode of this embodiment, when multiple keys are pressed at the same time, the first note pressed first is the main part, the second note is a harmonic part, and one of the two singing voices of a man and a woman is assigned to the main part and the other to the harmonic part.

FIG. 2 is a diagram showing an example of the external appearance of the electronic musical instrument 2. The electronic musical instrument 2 includes a keyboard 101 consisting of a plurality of keys as operators (performance operators), a switch panel 102 for instructing various settings, and an LCD 104 (Liquid Crystal Display) for performing various displays. Further, the electronic musical instrument 2 includes a speaker 214 on the back, side, or rear surface of the electronic musical instrument 2, which emits the musical instrument sounds and voices (singing voices) generated by the performance.

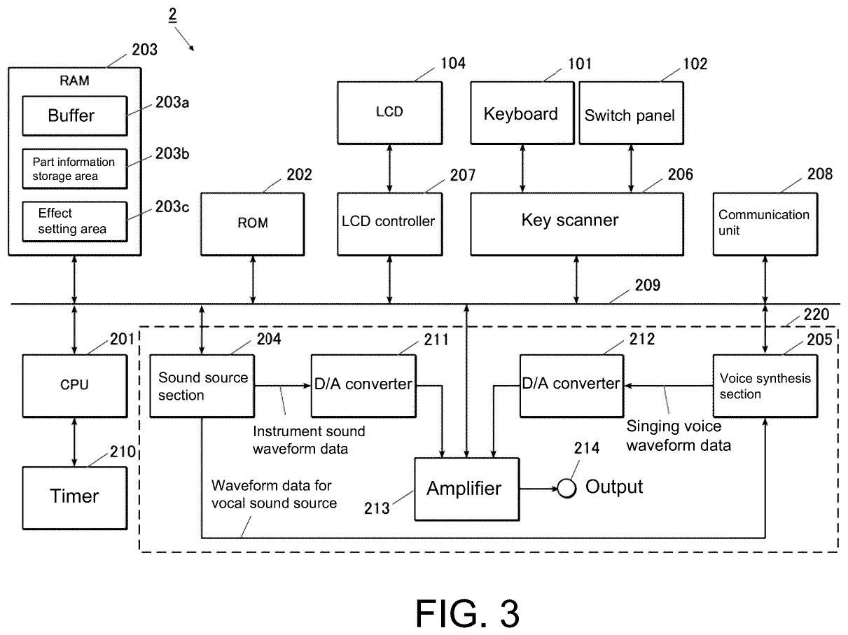

FIG. 3 is a block diagram showing the functional configuration of the control system of the electronic musical instrument 2. As shown in FIG. 3, the electronic musical instrument 2 includes a CPU (Central Processing Unit) 201 connected to a timer 210, a ROM (Read Only Memory) 202, a RAM (Random Access Memory) 203, a sound source section 204, and a voice synthesis section 205, an amplifier 213, a key scanner 206 to which the keyboard 101 and the switch panel 102 shown in FIG. 2 are connected, an LCD controller 207 to which the LCD 104 is connected, and a communication unit 208, which are respectively connected to a bus 209. In this embodiment, the switch panel 102 includes a singing voice production mode switch, which will be described later, and switches for setting various effects.

In addition, D/A converters 211 and 212 are connected to the sound source section 204 and the voice synthesis section 205, respectively, and the waveform data of the musical instrument sound outputted from the sound source section 204 and the audio waveform data of the singing voice outputted from the voice synthesis section 205 (singing voice waveform data) are converted into analog signals by D/A converters 211 and 212, respectively, amplified by an amplifier 213, and then are output (i.e., sounded) from a speaker 214. The sound source section 204, the voice synthesis section 205, the D/A converters 211 and 212, the amplifier 213, and the speaker 214 constitute a sound generation section 220. In this embodiment, a plurality of D/A converters will be described, but they can also be implemented with one D/A converter.

The CPU 201 is a computer (processor) that executes control operations for the electronic musical instrument 2 shown in FIG. 1 by executing programs stored in the ROM 202 while using the RAM 203 as a work memory. The CPU 201 implements the functions of the control section of the information processing apparatus of the present invention by executing key press/key release event processing and buffer processing, which will be described later, in cooperation with a program stored in the ROM 202. The ROM 202 stores programs, various fixed data, and the like.

The RAM 203 is provided with a buffer 203a for storing key press information and key release information in the singing voice production mode. Here, the buffer 203a is an array arranged in the order in which data are buffered. The RAM 203 also includes a part information storage area 203b for storing the pitch, velocity value, and male/female distinction of the main part, and the pitch, velocity value, and male/female distinction of the harmonic part in the singing voice production mode. Further, the RAM 203 is provided with an effect setting area 203c for storing parameter setting values (effect values) of various effects set by the switch panel 102. Examples of effects include vibrato, pitch bend, and the like.

The sound source section 204 also has a waveform ROM (not shown) that stores waveform data (instrument sound waveform data) of musical instrument sounds such as a piano, an organ, a synthesizer, stringed instruments, and wind instruments as well as excitation source waveform data for the vocal sound source in the singing voice production mode (waveform data for vocal sound source). The excitation source waveform data may be generated by a trained model.

For example, in the normal mode, the sound source section 204 reads instrument sound waveform data from, for example, a waveform ROM (not shown) based on pitch information and velocity values of pressed keys on the keyboard 101 in accordance with control instructions from the CPU 201, the read instrument sound waveform data is changed (for example, pitch changed) based on the set effect value, and is output to the D/A converter 211. Further, for example, in the singing voice production mode, the sound source section 204, in accordance with a control instruction from the CPU 201, reads out waveform data for the vocal sound source, which is either a male voice or female voice, from the waveform ROM (not shown) based on the pitch information and velocity value of the pressed key on the keyboard 101. The read-out waveform data is changed (for example, pitch changed) based on the set effect value, and is output to the voice synthesis section 205. The sound source section 204 can simultaneously output waveform data for multiple channels. The sound source section 204 is not limited to the PCM (Pulse Code Modulation) sound source method, and may use other sound source methods, such as an FM (Frequency Modulation) sound source method.

The voice synthesis section 205 includes a sound source generation section and a synthesis filter; generates (synthesizes) singing voice waveform data based on the singing voice parameters given from the CPU 201 and the waveform data for the vocal sound source inputted from the sound source section 204; and outputs it to D/A converter 212.

Note that the sound source section 204 and the voice synthesis section 205 may be configured by dedicated hardware such as LSI (Large-Scale Integration), or may be configured by software in cooperation with the CPU 201 and a program stored in the ROM 202.

The key scanner 206 regularly scans key press (KeyOn)/key release (KeyOff) of each key of the keyboard 101 in FIG. 2 and the operation status of the switch panel 102, and outputs the key press information/key release information (performance operation information) of the keyboard 101 and the operation information of the switch panel 103 to the CPU 201. Note that in this embodiment, the operation on a performance operator referred to in the present invention refers to a key press, and does not include a key release for canceling a key press operation.

The LCD controller 207 is an IC (integrated circuit) that controls the display state of the LCD 104. The communication unit 208 sends and receives data to and from an external device such as the terminal device 3 connected via a communication network N such as the Internet or a communication interface I such as a USB (Universal Serial Bus) cable.

### <Configuration of Terminal Device 3>

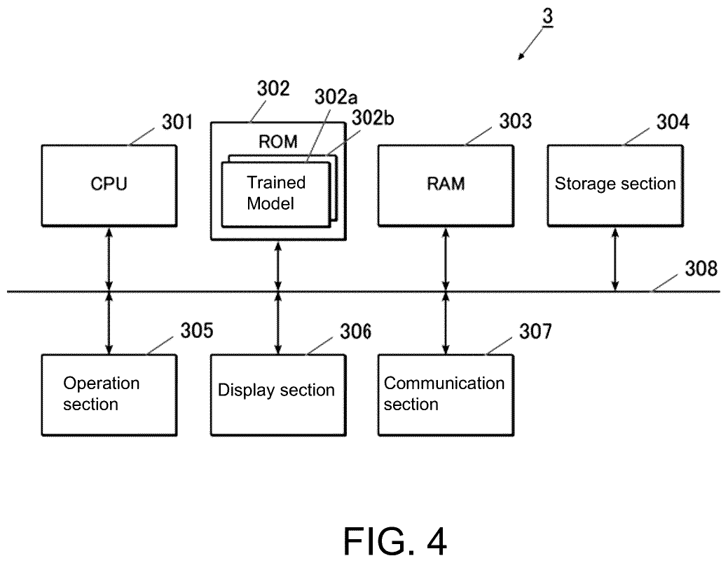

FIG. 4 is a block diagram showing the functional configuration of the terminal device 3 in FIG. 1. As shown in FIG. 4, the terminal device 3 is a computer configured with a CPU 301, ROM 302, RAM 303, storage section 304, operation section 305, display section 306, communication section 307, etc., and respective sections are connected by a bus 308. As the terminal device 3, for example, a tablet PC (Personal Computer), a notebook PC, a smartphone, etc., can be used.

The ROM 302 of the terminal device 3 is loaded with a trained model 302a and a trained model 302b. The trained model 302a and the trained model 302b are respectively generated by machine learning of a plurality of data sets constituted of musical score data (lyrics data (lyrics text information) and pitch data (including note length information)) of a plurality of singing songs, and singing voice waveform data created when a singer sings each of these songs. The trained model 302a is a male singing voice model generated by machine learning of singing voice waveform data of a certain male singer. The trained model 302b is a female singing voice model generated by machine learning of singing voice waveform data of a certain female singer. When the trained model 302a and the trained model 302b are input with lyrics data and pitch data of an arbitrarily chosen song (which can be a phrase), the trained model 302a and the trained model 302b respectively infer a group of singing voice parameters (referred to as singing voice information) for producing the same singing voice as the singer who was used in producing the respective trained models by singing predetermined songs.

### <Singing Voice Production Mode Operation>

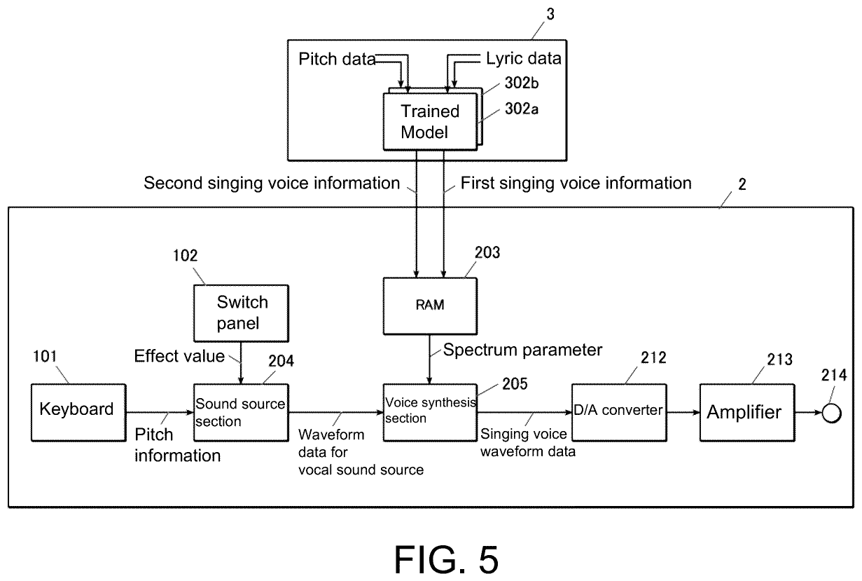

FIG. 5 is a diagram showing a configuration related to the production of singing voices in response to key press operations on the keyboard 101 in the singing voice production mode. Hereinafter, with reference to FIG. 5, an explanation will be given of the operation of the electronic musical instrument 2 when it produces a singing voice in response to a key press operation on the keyboard 101 in the singing voice production mode.

If the user wishes to perform in the singing voice production mode, the user presses the singing voice production mode switch on the switch panel 102 of the electronic musical instrument 2 to instruct the transition to the singing voice production mode. When the singing voice production mode switch is pressed, the CPU 201 shifts the operation mode to the singing voice production mode.

Next, into the terminal device 3, the user inputs the lyrics data and pitch data (score data) of an arbitrary singing song that the user wants the electronic musical instrument 2 to produce in the singing voice production mode using a dedicated application or the like.

Alternatively, lyrics data and pitch data of plural singing songs may be stored in the storage section 304, and lyrics data and pitch data of a singing song may be selected from those stored in the storage section 304. In the terminal device 3, when the lyrics data and pitch data of the singing song that is determined to be produced in the singing voice production mode are input, the CPU 301 inputs these lyrics data and pitch data of the input singing song into the trained model 302a and the trained model 302b so that they respectively infer singing voice parameter groups, and causes the communication section 307 to transmits singing voice information, which is the inferred singing voice parameter groups, to the electronic musical instrument 2. The male singing voice information inferred by the trained model 302a is referred to as first singing voice information. The female singing voice information inferred by the trained model 302b is referred to as second singing voice information.

Here, singing voice information will be explained. Each section of a singing song divided into predetermined time units in the time domain is called a frame, and the trained model 302a and the trained model 302b generate singing voice parameters in units of frames. That is, the singing voice information of one singing song generated by each trained model is composed of a plurality of singing voice parameters (time-series singing voice parameter group) in units of frames. The frame-by-frame singing voice parameters include a spectral parameter (frequency spectrum of voice to be produced) and a fundamental frequency FO parameter (pitch frequency of voice to be produced).

In the electronic musical instrument 2, when the communication unit 208 receives singing voice information (the first singing voice information generated by the trained model 302a and the second singing voice information generated by the trained model 302b) from the terminal device 3, the CPU 201 causes the received singing voice information to be stored in the RAM 203.

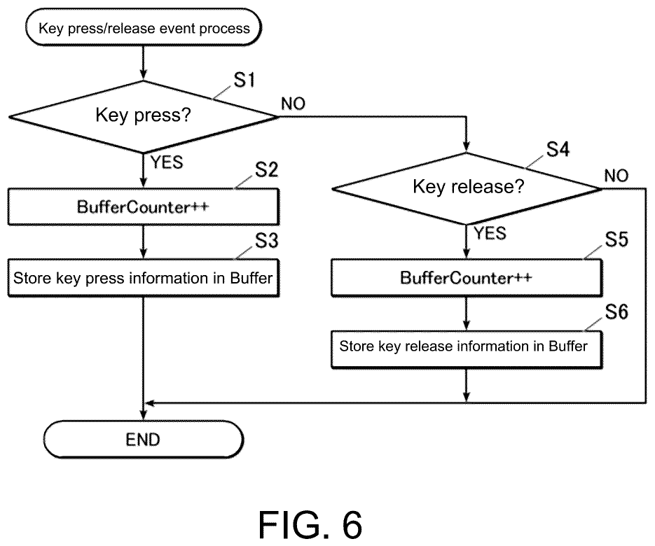

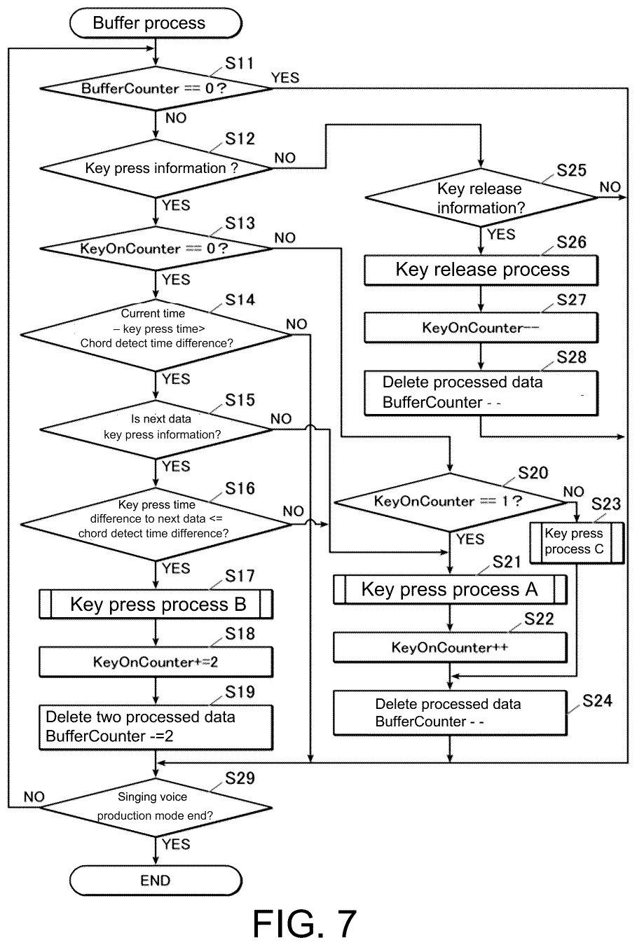

When the registration of the singing voice information in the RAM 203 is completed, the CPU 201 sets (initializes) the variables BufferCounter and KeyOnCounter to 0. BufferCounter is a variable for counting the number of data stored in the buffer 203a. KeyOnCounter is a variable for counting the number of notes that are being produced (notes that continue to be produced). The CPU 201 executes key press/key release event processing (see FIG. 6) each time performance operation information is input from the key scanner 206 while operating in the singing voice production mode. Further, the CPU 201 executes buffer processing (see FIG. 7) while operating in the singing voice production mode. Below, key press/key release event processing and buffer processing will be explained.

FIG. 6 is a flowchart showing the flow of key press/key release event process. The key press/key release event process is executed in cooperation with the CPU 201 and the program stored in the ROM 202 when performance operation information is input from the key scanner 206.

In the key press/key release event process, the CPU 201 first determines whether any key on the keyboard 101 has been pressed based on performance operation information input from the key scanner 206 (step S1).

If it is determined that any key on the keyboard 101 has been pressed (step S1; YES), the CPU 201 increments BufferCounter (step S2), stores pressed key information in the buffer 203a (step S3), and ends the key press/release event process. The key press information stored in the buffer 203a includes the key press time, the pitch (key number) of the pressed key, and the velocity value. The key release information includes at least the pitch (key number) of the released key. The key release information does not include time information.

On the other hand, if it is determined in step S1 that any key on the keyboard 101 is not pressed (step S1; NO), the CPU 201 determines whether any key on the keyboard 101 has been released based on the performance operation information input from the key scanner 206 (step S4). If it is determined that any key on the keyboard 101 has been released (step S4; YES), the CPU 201 increments BufferCounter (step S5), stores the released key information in the buffer 203a (step S6), and ends the key press/key release event process.

If it is determined that no key on the keyboard 101 has been released (step S4; NO), the CPU 201 ends the key press/key release event process.

FIG. 7 is a flowchart showing the flow of the buffer processing. Buffer processing is executed in cooperation with the CPU 201 and the program stored in the ROM 202 during operation in the singing voice production mode.

In the buffer process, the CPU 201 first determines whether the value of BufferCounter is 0 (step S11). If the CPU 201 determines that the value of BufferCounter is 0 (step S11; YES), the CPU 201 moves to step S29.

If it is determined that the value of BufferCounter is not 0 (step S11; NO), the CPU 201 determines whether or not the leading data (i.e., data stored at the beginning) among the data stored in the buffer 203a is key press information (step S12). Here, the leading data refers to data stored first in the buffer 203a among the data stored in the buffer 203a. Note that whether the data is key press information or key release information can be determined based on whether or not the data includes time information.

If it is determined that the leading data is key press information (step S12; YES), it is determined whether the value of KeyOnCounter is 0 (step S13).

If it is determined that the value of KeyOnCounter is 0 (step S13; YES), the CPU 201 determines whether or not (the current time—key press time)>chord detect time difference (step S14). The key press time in step S14 is the key press time included in the leading data stored in the buffer 203a. The chord detect time difference is a time difference (on the order of several milliseconds) for determining whether a certain key press and a subsequent key press specify a chord. Step S14 is determining whether the elapsed time from the key press time included in the leading data exceeds the chord detect time difference.

If it is determined that (the current time—key press time)>chord detect time difference is not satisfied (step S14; NO), the CPU 201 moves to step S29.

If it is determined that (the current time—key press time)>chord detect time difference (step S14; YES), the CPU 201 determines whether the next data stored in the buffer 203a is key press information (step S15). If it is determined that the next data stored in the buffer 203a is not key press information (step S15; NO), the CPU 201 executes the key press process A (step S21). In other words, when a single key (first performance operator) is pressed without any key being pressed on the keyboard 101, and the next key (second performance operator) press is not detected within the chord detect time after the first single key is pressed (that is, when one key alone is pressed), the key press process A is executed. In the key press process A, one key's sound is produced. The key press process A will be described later.

When the key press process A is completed, the CPU 201 increments KeyOnCounter (step S22), deletes the processed data (the leading data) from the buffer 203a, and decrements BufferCounter (step S24), and proceeds to step S29.

On the other hand, if it is determined that the next data stored in the buffer 203a is key press information (step S15; YES), the CPU 201 determines whether the key press time difference with the next key press information is within the chord detect time difference (step S16). That is, the CPU 201 determines whether the leading key press information and the next key press information indicates a chord (keys pressed at the same time).

If it is determined that the key press time difference with the next key press information is within the chord detect time difference (step S16; YES), the CPU 201 executes the key press process B (step S17). That is, when a single key (first performance operator) is pressed while no key on the keyboard 101 is being pressed, and the next key (second performance operator) is pressed within the chord detect time while the first key (the first performance operator) is continued to be pressed (i.e., when two keys are pressed at the same time (a chord is played)), the key press process B is executed. In the key press process B, two keys are sound-produced. The key press process B will be described later.

When the key press process B ends, the CPU 201 adds 2 to KeyOnCounter (step S18), deletes the processed data (leading data and next data) from the buffer 203a, subtracts 2 from BufferCounter (step S19), and moves to step S29.

On the other hand, if it is determined in step S13 that KeyOnCounter is not 0 (step S13; NO), the CPU 201 determines whether KeyOnCounter is 1 (step S20). If it is determined that KeyOnCounter is 1 (step S20; YES), the CPU 201 executes the key press process A (step S21). In other words, when a single key (first performance operator) is pressed while no key on the keyboard 101 has been pressed, and the next key (second performance operator) is pressed after the chord judgment time has elapsed since the single key was pressed while the previous key is being pressed (the first key depression continues), the key press process A is executed. In the key press process A, the sound of a single key press is produced. The key press process A will be described later.

When the key press process A is completed, the CPU 201 increments KeyOnCounter (step S22), deletes the processed data (the leading data) from the buffer 203a, decrements BufferCounter (step S24), and proceeds to step S29.

In step S20, if it is determined that KeyOnCounter is not 1 (step S20; NO), that is, if KeyOnCounter is 2 or more, the CPU 201 executes the key press process C (step S23). The key press process C is a process in which when a new key is pressed (operation of a third performance operator) while sound generation continues for two pressed keys (operations of the first and second performance operators), a sound corresponding to the new key press is produced. The key press process C will be described later.

When the key press process C ends, the CPU 201 deletes the processed data (the leading data) from the buffer 203a, decrements BufferCounter (step S24), and proceeds to step S29.

On the other hand, if it is determined in step S12 that the leading data is not key press information (step S12; NO), the CPU 201 determines whether the leading data is key release information (step S25). If it is determined that the leading data is key release information (step S25; YES), the CPU 201 performs key release process based on the key release information (step S26). In the key release process, the CPU 201 controls the sound generation section 220 to mute the singing voice at the pitch specified by the key release information.

When the key release process is completed, the CPU 201 decrements the KeyOnCounter (step S27), deletes the processed data (the leading data) from the buffer 203a, decrements the BufferCounter (step S28), and proceeds to step S29.

If it is determined that the leading data is not key release information (step S25; NO), the CPU 201 moves to step S29.

In step S29, the CPU 201 determines whether the singing voice production mode has ended (step S29). For example, when the singing voice production mode switch is pressed and a transition to the normal mode is instructed, the CPU 201 determines that an instruction has been given to end the singing voice production mode. If it is determined that the singing voice production mode has not ended (step S29; NO), the CPU 201 returns to step S11. If it is determined that the singing voice production mode has ended (step S29; YES), the CPU 201 ends the buffer processing.

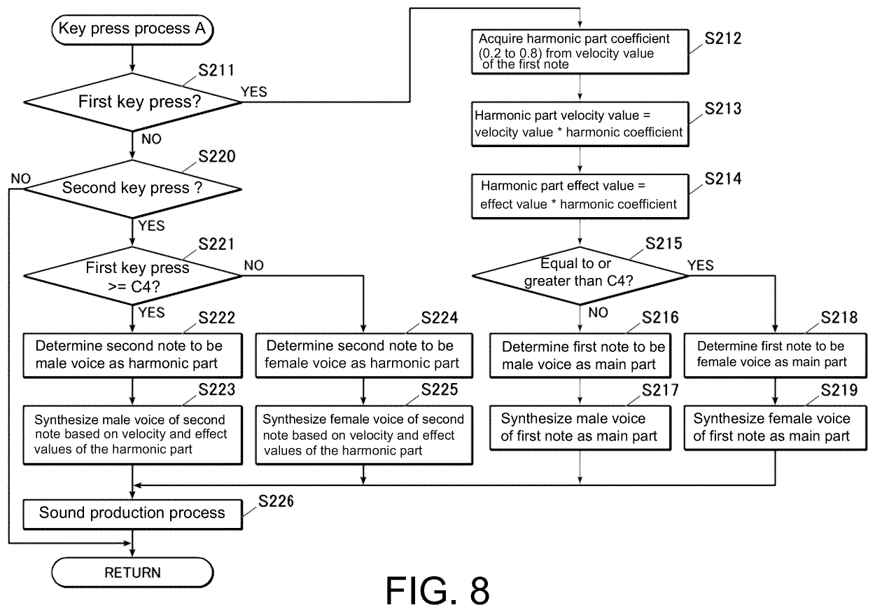

The key press processes A to C will be explained below. FIG. 8 is a flowchart showing the flow of the key press process A. The key press process A is executed in cooperation with the CPU 201 and a program stored in the ROM 202.

In the key press process A, first, the CPU 201 determines whether the data at the head of the buffer 203a (the leading data) is key press information for the first note (step S211). If KeyOnCounter is 0, the CPU 201 determines that this is key press information for the first note. If KeyOnCounter is 1, it is determined that this is the key press information for the second note.

If it is determined that the data at the head of the buffer 203a (the leading data) is the key press information for the first note (step S211; YES), the CPU 201 obtains a harmonic part coefficient based on the velocity value of the data (step S212).

Here, it is preferable that the harmonic part be produced smaller than the main part so that the harmonic part does not stand out more than the main part and brings out the main part. Therefore, the CPU 201 sets a value obtained by multiplying the velocity value of the main part by a harmonic part coefficient (0<harmonic part coefficient<1) as the velocity value of the harmonic part. For example, a conversion table of the velocity values and a harmonic part coefficient may be stored in the ROM 202, such that as the velocity value changes from 0 to 127, a harmonic part coefficient changes linearly from 0.2 to 0.8. And at step S212, a harmonic part coefficient may be acquired based on the conversion table. Note that the range of a harmonic part coefficient may be desirably set by the user using the switch panel 102 or the like.

Next, the CPU 201 calculates the harmonic part velocity value by multiplying the velocity value of the key press information of the first note by a harmonic part coefficient (step S213). Further, the CPU 201 multiplies an effect value such as vibrato depth by a harmonic part coefficient to calculate a harmonic part effect value (step S214).

Next, the CPU 201 determines whether the pitch of the key press information for the first note is equal to or higher than a predetermined reference value (in this embodiment, C4) (step S215). Here, the reference value is not limited to C4.

If it is determined that the pitch of the key press information of the first note is not higher than C4 (step S215; NO), the CPU 201 sets the first note as the main part; determines the singing voice of the main part to be a male singer's singing voice; and stores the fact that the main part is male and the pitch and velocity values of the main part in the part information storage area 203b (step S216). Then, the CPU 201 causes the sound generation section 220 to synthesize the male singer's singing voice corresponding to the first note (main part) (step S217), causes the synthesized singing voice to be produced (step S226), and ends the key press process A.

In step S217, the CPU 201 inputs the pitch (note number) and velocity value included in the key press information of the first note, and the effect setting value (effect value) stored in the effect setting area 203c to the sound source unit 204; causes the sound source unit 204 to generate vocal sound source waveform data (excitation source waveform data) of a male voice tone according to the input pitch, velocity value, and effect value; and inputs the data to the voice synthesis section 205. Further, the CPU 201 acquires the spectrum parameters of the frame corresponding to the key press time from the first singing voice information stored in the RAM 203 and inputs it to voice synthesis section 205. Then, the CPU 201 causes the voice synthesis section 205 to generate (synthesize) the male singer's singing voice waveform data based on the input spectrum parameters and the vocal sound source waveform data. In step S226, the CPU 201 causes the D/A converter 212 to convert the generated singing voice waveform data into an analog audio signal and to output (sound-generates) the analog audio signal via the amplifier 213 and speaker 214.

On the other hand, in step S215, if it is determined that the pitch of the key press information of the first note is C4 or higher (step S215; YES), the CPU 201 sets the first note as the main part, and selects a female singer's singing voice as the singing voice of the main part. The CPU 201 then causes the part information storage area 203b to store the fact that the main part is a female and the pitch and velocity values of the main part (step S218). Then, the CPU 201 causes the sound generation section 220 to synthesize the singing voice corresponding to the first note (main part) with the female singer's singing voice (step S219), causes the synthesized singing voice to sound (step S226), and ends the key press processing A.

In step S219, the CPU 201 inputs the pitch (note number) and velocity value included in the key press information of the first note, and the effect setting value stored in the effect setting area 203c to the sound source section 204; causes the sound source section 204 to generate vocal sound source waveform data (excitation source waveform data) of a female voice tone according to the input pitch, velocity value, and effect value; and inputs it to the voice synthesis section 205. Further, the CPU 201 acquires the spectrum parameter of the frame corresponding to the key press time from the second singing voice information stored in the RAM 203, and inputs it to the voice synthesis section 205. Then, the CPU 201 causes the voice synthesis section 205 to generate (synthesize) the female singer's singing voice waveform data based on the input spectrum parameters and the vocal sound source waveform data.

On the other hand, if it is determined in step S211 that the leading data is not key press information for the first note (step S211; NO), the CPU 201 determines whether the leading data is key press information for the second note (step S220). If it is determined that the leading data is not the key press information for the second note (step S220; NO), the CPU 201 ends the key press process A.

If it is determined that the leading data is key press information for the second note (step S220; YES), the CPU 201 determines whether the pitch of the first note (main part) is C4 or higher (step S221). If it is determined that the pitch of the first note is C4 or higher (step S221; YES), that is, if the main part is a female singer, the CPU 201 sets the second note as a harmonic part, and determines the singing voice of the harmonic part to be voice of a male singer, and stores the fact that the harmonic part is male and the pitch and velocity values of the harmonic part in the part information storage area 203b (step S222). Then, the CPU 201 causes the sound generation section 220 to synthesize the singing voice corresponding to the second note (harmonic part) with the male singer's singing voice using the harmonic part velocity value and the harmonic part effect value (step S223), causes the resulting harmonic singing voice to be produced (step S226), and ends key press process A. The processing in step S223 is the same as that explained in step S217 and the explanation for step S217 also applies to step S223 except that the pitch (note number) input to the sound source section 204 is the second note, the input velocity value is the harmonic part velocity value, and the effect value is the harmonic part effect value.

On the other hand, if it is determined that the pitch of the first key pressed is not C4 or above (step S221; NO), that is, if the main part is male, the CPU 201 determines the second note as the harmonic part singing voice to be voice of a female singer, and stores the fact that the harmonic part is woman and the pitch and velocity values of the harmonic part in the part information storage area 203b (step S224). Then, the CPU 201 causes the sound generation section 220 to synthesize the singing voice corresponding to the second note (harmonic part) with the female singer's singing voice using the harmonic part velocity value and the harmonic part effect value (step S225); causes the resulting harmonic singing voice to be produced (step S226), and ends the key press process A. The processing in step S225 is the same as that explained in step S219 and the explanation of S219 applies to step S225 except that the pitch (note number) input to the sound source section 204 is the second note, the velocity value input is set as the harmonic part velocity value, and the effect value is set as the harmonic part effect value.

As described above, if a key press for the second note is detected while the first note continues to be produced, and the second note is pressed after the chord detect time has elapsed, the CPU 201 sets the first note as the main note and sets the second note as a harmonic part. If the pitch of the first note is equal to or higher than a predetermined reference value, the main part is produced with the singing voice of a female singer, and the harmonic part is produced with the singing voice of a male singer. If the pitch of the first note is lower than the predetermined reference value, the main part is produced by a male singer's singing voice, and the harmonic part is produced by a female singer's singing voice. Therefore, harmony between a plurality of singing voices can be realized. In addition, the CPU 201 sets the velocity value of the harmonic part to a value obtained by multiplying the velocity value of the main part by a harmonic part coefficient (0<harmonic part coefficient<1), so that the harmonic part is controlled to sound smaller than the main part. Therefore, it is possible to make the harmonic part sound so as to complement the main part. The CPU 201 also controls effects such as the vibrato depth of the harmonic part so that the strength of the harmonic part effect is smaller than that of the main part by multiplying the currently set value by a harmonic part coefficient. Therefore, it is possible to make the harmonic part sound so as to complement the main part.

Next, the key press process B will be explained.

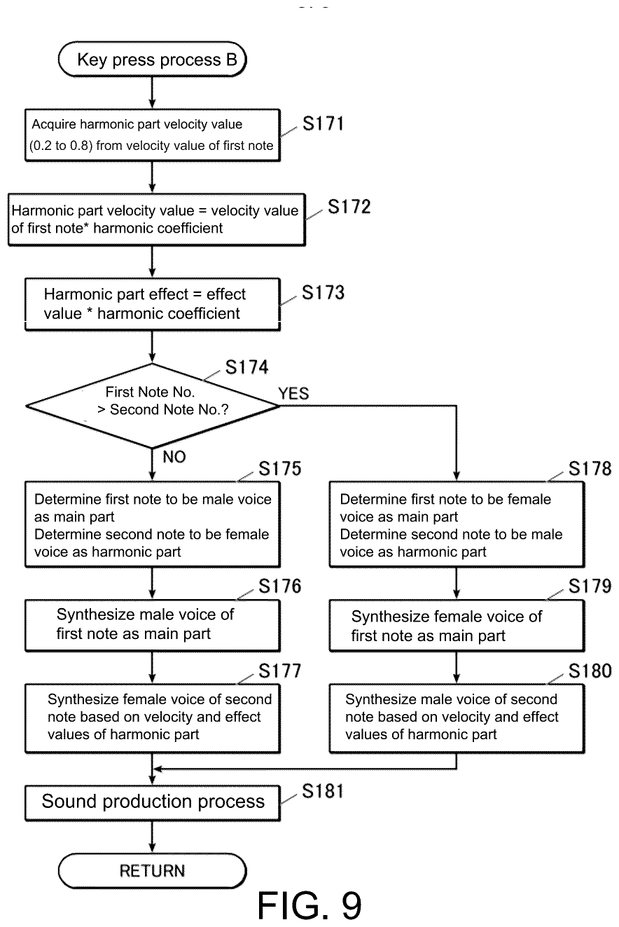

FIG. 9 is a flowchart showing the flow of the key press process B. The key press process B is executed in cooperation with the CPU 201 and a program stored in the ROM 202.

In the key press process B, the CPU 201 first determines a harmonic part coefficient based on the velocity value of the leading data (key press information of the first note) in the buffer 203a (step S171). The process in step S171 is similar to that explained in step S212 of FIG. 8, so the same explanation is applicable here.

Next, the CPU 201 multiplies the velocity value of the key press information of the first note by a harmonic part coefficient to calculate the harmonic part velocity value (step S172). Further, the CPU 201 multiplies an effect value such as vibrato depth by a harmonic part coefficient to calculate a harmonic part effect value (step S173).

Next, the CPU 201 determines whether the first note No.>second note No. (step S174). Here, the second note No. can be obtained from the key press information of the second note. The key press information for the second tone is the key press information stored in the buffer 203a next to the leading data in the buffer 203a.

If first note No.>second note No. is not satisfied (step S174; NO), the CPU 201 sets the first note as the main part to be the singing voice of a male singer, sets the second note as the harmonic part to be the singing voice of a female singer, and stores the gender, pitch, and velocity value of respective singing voices of the main part and harmonic part in the part information storage area 203b (step S175).

Next, the CPU 201 causes the sound generation section 220 to synthesize the male singer's singing voice corresponding to the first note as the main part (step S176). The process in step S176 is similar to that of step S217 in FIG. 8, so the same description applies here.

Next, the CPU 201 causes the sound generation section 220 to synthesize the female singer's singing voice corresponding to the second note as the harmonic part using the harmonic part velocity value and the harmonic part effect value (step S177) and proceeds to step S181. The process in step S177 is similar to that explained in step S225 of FIG. 8, so the same explanation applies here.

On the other hand, in step S174, if first note No.>second note No. is satisfied (step S174; YES), the CPU 201 sets the first note as the main part to be the female singer's singing voice, sets the second note as the harmonic part to be the male singer's singing voice, and stores the gender, pitch, and velocity values of the respective singing voices of the main part and harmonic part in the part information storage area 203b (step S178).

Next, the CPU 201 causes the sound generation section 220 to synthesize the female singer's singing voice corresponding to the first note as the main part (step S179).

The process in step S179 is similar to step S219 in FIG. 8, so the same description applies here.

Next, the CPU 201 causes the sound generation section 220 to synthesize the male singer's singing voice corresponding to the second note as a harmonic part using the harmonic part velocity value (step S180) and proceeds to step S181. The process in step S180 is similar to that explained in step S223 of FIG. 8, so the same explanation applies here.

In step S181, the CPU 201 causes the sound generation section 220 to generate a singing voice based on the synthesized singing voice waveform data (step S181), and ends key press process B.

As mentioned above, when it is determined that the second note is pressed within the chord detect time after the first note is pressed, that is, when it is determined that two keys are pressed at the same time (playing a chord), the CPU 201 sets the first note as the main part and the second note as a harmonic part. If the pitch of the first note is lower than the pitch of the second note, the CPU 201 sets the main part to be the singing voice of a male singer and the harmonic part to be the singing voice of a female singer. If the pitch of the first note is higher than the pitch of the second note, the main part is produced by a female singer's singing voice, and the harmonic part is produced by a male singer's singing voice. Therefore, harmony between a plurality of singing voices can be realized. In addition, the CPU 201 sets the velocity value of the harmonic part to a value obtained by multiplying the velocity value of the main part by a harmonic part coefficient (0<harmonic part coefficient<1), so that the harmonic part is sounded smaller than the main part. Therefore, it is possible to make the harmonic part sound so as to complement the main part. The CPU 201 also controls effects such as the vibrato depth of the harmonic part so that the strength (intensity) of the harmonic part effect is smaller than that of the main part by multiplying the currently set value by a harmonic part coefficient. Therefore, it is possible to make the harmonic part sound so as to complement the main part.

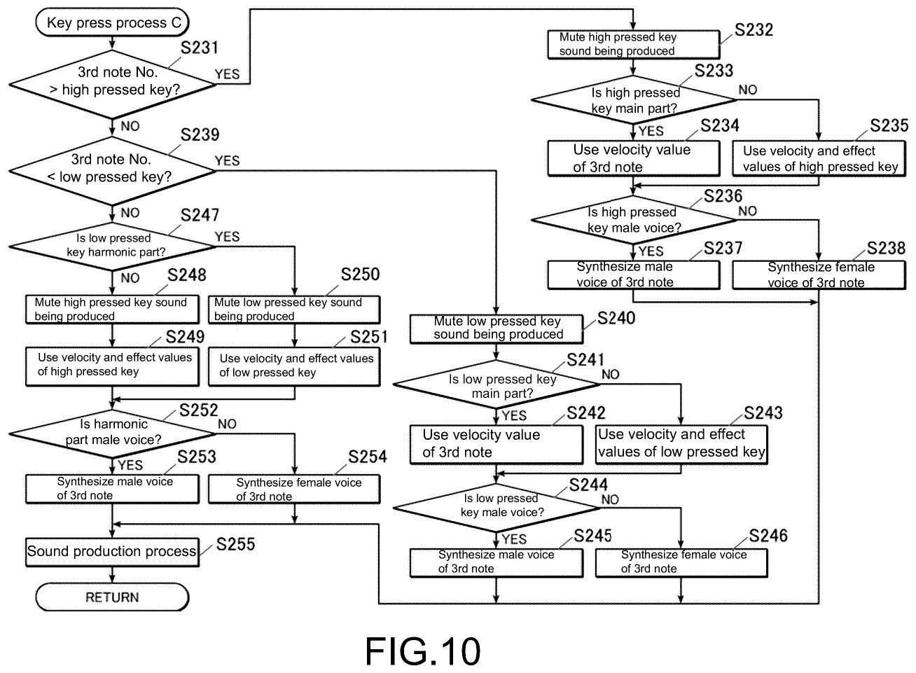

Next, the key press process C will be explained. FIG. 10 is a flowchart showing the flow of key press process C. The key press process C is executed in cooperation with the CPU 201 and a program stored in the ROM 202.

In the key press process C, the CPU 201 first determines whether the third note No.>Note No. of high pressed key (step S231). Here, the higher of the two sounds currently being sounded is referred to as the high pressed key sound, and the lower of the two currently sounding tones is referred to as low pressed key sound. That is, it is determined whether or not the Note No. of the leading data (key press information of the third note) of the buffer 203a is the greater than the Note No. of the higher of the two notes currently being sounded.

If the Note No. of the leading data (key press information of the third note) in the buffer 203a is greater than the Note No. of the high pressed key (step S231; YES), the CPU 201 controls the sound generation section 220 to mute the singing voice of the high pressed key (step S232).

Next, the CPU 201 determines whether the high pressed key was for the main part (step 233). The CPU 201 refers to the part information storage area 203b to determine whether or not the high pressed key was for the main part. If the CPU 201 determines that the high pressed key was for the main part (step S233; YES), the CPU 201 determines the velocity value of the third note key press as the velocity value to be used for sound generation (step S234) and moves to step S236.

If it is determined that the high pressed key was not the main part (it was a harmonic part) (step S233; NO), the CPU 201 determines the velocity value and effect value of the third key press as the velocity value and effect value to be used (step S235), and moves to step S236. That is, when the high pressed key was for the harmonic part, the harmonic part velocity value and the harmonic part effect value are used to produce the third note.

In step S236, the CPU 201 determines whether or not the high pressed key generated the male singing voice (step S236). The CPU 201 refers to the part information storage area 203b to determines whether or the high pressed key generated the singing voice of a male singer.

If it is determined that the high pressed key generated the singing voice of a male singer (step S236; YES), the CPU 201 causes the sound generation section 220 to synthesize the singing voice of the male singer corresponding to the third note (step S237) and proceeds to step S255.

If the high pressed key was for the main part, the process in step S237 is the same as that explained in step S217 except that the pitch (note number) input to the sound source section 204 is set to that of the third note, and the velocity value is set to the velocity value determined in step S234. So the same explanation applies here. If the high pressed key was for the harmonic part, the process in step S237 is the same as that explained in step S223 except that the pitch (note number) input to the sound source section 204 is that of the third note, and the velocity value and effect value to be input are the velocity value and effect value determined in step S235. So the same explanation applies here.

If it is determined that the high pressed key generated the singing voice of a female singer (step S236; NO), the CPU 201 causes the sound generation section 220 to synthesize the singing voice of the female singer corresponding to the third note (step S238) and proceeds to step S255.

If the high pressed key was for the main par, the process in step S238 is the same as that explained in step S219 except that the pitch (note number) input to the sound source section 204 is set to that of the third note, and the velocity value to be input is determined in step S234. So, the same explanation apply here. If the high pressed key was for the harmonic part, the process in step S238 is the same as that explained in step S225 except that the pitch (note number) input to the sound source section 204 is that of the third note, and the velocity value and effect value to be input are the velocity value and effect value determined in step S235. So the same explanation applies here.

On the other hand, in step S231, if the Note No. of the leading data (key press information of the third note) in the buffer 203a is equal to or less than Note No. of the high pressed key, the CPU 201 determines whether or not the third Note No.<Note No. of the low pressed key (step S239).

If it is determined that the third Note NO.<Note No. of low pressed key (step S239; YES), the CPU 201 controls the sound generation section 220 to mute the singing voice of the low pressed key that is being produced (step S240).

Next, the CPU 201 determines whether or not the low pressed key was for the main part (step 241). The CPU 201 refers to the part information storage area 203b to determine whether or not the low pressed key was for the main part. If it is determined that the low pressed key was for the main part (step S241; YES), the CPU 201 determines the velocity value of the third note as the velocity value to be used for sound generation (step S242) and proceeds to step S244.

If it is determined that the low pressed key was not for the main part (step S241; NO), the CPU 201 determines the velocity value and effect value of the low pressed key as the velocity value and effect value used for sound generation, respectively (step S243), and moves to step S244. That is, when the low pressed key was for a harmonic part, the harmonic part velocity value and the harmonic part effect value are used to generate the third note.

In step S244, the CPU 201 determines whether or not the low pressed key generated the singing voice of a male singer (step S244). The CPU 201 refers to the part information storage area 203b to determine whether or not the low pressed key generated the singing voice of a male singer. If it is determined that the low pressed key generated the singing voice of a male singer (step S244; YES), the CPU 201 causes the sound generation section 220 to synthesize the singing voice of the male singer corresponding to the third note (step S245) and proceeds to step S255.

If the low pressed key was for the main part, the process in step S245 is the same as that explained in step S217 except that the pitch (note number) input to the sound source section 204 is set to that of the third note, and the velocity value is set to the velocity value determined in step S242. So, the same explanation applies here. If the low pressed key was for a harmonic part, the process in step S245 is the same as that explained in step S223 except that the pitch (note number) input to the sound source section 204 is set to that of the third note, and the velocity value and effect value to be input are set to the velocity value and effect value determined in step S243. So the same explanation applies here.

If it is determined that the low pressed key generated the singing voice of a female singer (step S244; NO), the CPU 201 causes the sound generation section 220 to synthesize the singing voice of the female singer corresponding to the third note (step S246) and proceeds to step S255.

If the low pressed key was for the main part, the process in step S246 is the same as that explained in step S219 except that the pitch (note number) input to the sound source section 204 is set to that of the third note, and the velocity value is set to the velocity value determined in step S242. So the same explanation applies here. If the low pressed key was for a harmonic part, the process in step S246 is the same as that explained in step S225 except that the pitch (note number) input to the sound source section 204 is set to that of the third note, and the velocity value and effect value to be input are set to the velocity value and effect value determined in step S243. So, the same explanation applies here.

On the other hand, in step S239, if it is determined that the third Note No.<Note No. of the low pressed key is not satisfied (step S239; NO), that is, if the third Note No. is between the high pressed key and the low pressed key, the CPU 201 determines whether the low pressed key was for a harmonic part (step 247). The CPU 201 refers to the part information storage area 203b to determine whether the low pressed key was for a harmonic part.

If it is determined that the low pressed key was not for a harmonic part (step S247; NO), that is, if it is determined that the low pressed key was for the main part, the CPU 201 controls the sound generation section 220 to mute the singing voice of the high pressed key that is being produced as the harmonic part (step S248). Then, the CPU 201 determines the velocity value and effect value of the high pressed key as the velocity value and effect value, respectively, to be used for sound generation (step S249) and proceeds to step S252.

If it is determined that the low pressed key was for a harmonic part (step S247; YES), the CPU 201 controls the sound generation section 220 to mute the singing voice of the low pressed key that is being generated as the harmonic part (step S250). Then, the CPU 201 determines the velocity value and effect value of the low pressed key as the velocity value and effect value, respectively, to be used for sound generation (step S251) and proceeds to step S252.

In step S252, the CPU 201 determines whether the harmonic part is the singing voice of a male singer (step S252). The CPU 201 refers to the part information storage area 203b to determine whether the harmonic part is the singing voice of a male singer.

If it is determined that the harmonic part was the singing voice of a male singer (step S252; YES), the CPU 201 causes the sound generation section 220 to synthesize the singing voice of a male singer corresponding to the third note (step S253) and proceeds to step S255.

The process in step S253 is the same as that explained in step S223, except that the pitch (note number) input to the sound source section 204 is set to that of the third note and the velocity value and effect value to be input are set to the velocity value and effect value determined in step S249 or S251. So the same explanation applies here.

If it is determined that the harmonic part was the singing voice of a female singer (step S252; NO), the CPU 201 causes the sound generation section 220 to synthesize the singing voice of a female singer corresponding to the third note (step S254) and proceeds to step S255.

The process in step S254 is the same as that explained in step S225 except that the pitch (note number) input to the sound source section 204 is set to that of the third note, and the velocity value and effect value are set to the velocity value and effect value determined in step S249 or S251. So the same explanation applies here.

In step S255, the CPU 201 causes the sound generation section 220 to generate a singing voice based on the synthesized singing voice waveform data (step S255), and ends the key press process C.

As described above, when the third note is pressed while the sound generation for the two pressed keys continues, the CPU 201 executes the key press process C to control whether the third note is produced with the singing voice of a male singer or the singing voice of a female singer, based on comparison of the pitch of the third note with pitches of the first and second notes.

For example, if the third note has a higher pitch than the two notes being produced, the current singing voice of the high pressed key is muted, and the third note is produced with the singing voice of the high pressed key. If the third note has a lower pitch than the two notes being produced, the current singing voice of the low pressed key is muted, and the third note is produced with the singing voice of the low pressed key. If the third note has a pitch between the two notes that are being produced, priority is given to preserving the melody sound, and the harmonic part is muted, and the third note is produced with the singing voice of the harmonic part.

Therefore, if the pitch of the third note is higher (highest note) or lower (lowest note) than the pitches of the two notes being sounded, the highest note and lowest note among the three notes are used to create a harmony Furthermore, if the third note is a note between two notes that are being produced, it is possible to give priority to preserving the melody sound and make the third note sound with the singing voice of the harmonic part.

As explained above, if a first note key press (an operation on a first performance operator) is detected while no key on the keyboard 101 has been pressed and if a second note key press (an operation on the second performance operator) is detected while the first note key press continues, the CPU 201 of the electronic musical instrument 2 causes the sound generation section 220 to sound-produce the first note corresponding to the first note key press and the second note corresponding to the second note press with mutually different singers' voices. For example, the note corresponding to the first key press is produced by one of the singing voices of a male singer and a female singer, and the note corresponding to the second key press is produced by the other of the two singing voices. Therefore, when a plurality of keys are pressed at the same time on the electronic musical instrument 2, a harmony between the plurality of singing voices can be realized even if the plurality of pressed keys are in the same pitch range.

For example, if the second key press is detected within the chord detect time after the first key press is detected, that is, in the case of playing a chord, the CPU 201 compares the pitch of the first note and the second note, and based on the comparison results, the CPU 201 determines a singing voice of the first note to be produced and a singing voice of the second note to be produced among the singing voices of a male singer (first singer) and a female singer (second singer). Therefore, depending on the comparison result between the pitches of the first note and the pitch of the second note, it is possible to appropriately determine the singing voice for producing each note in the chord.

Further, for example, if the second note is not detected within the chord detect time after the first note is detected (the second note is detected after the chord detect time has elapsed), the CPU 201 determines a singing voice of the first note to be produced and a singing voice of the second note to be produced among the singing voices of a male singer (first singer) and a female singer (second singer) based on whether the pitch of the first note is equal to or higher than a predetermined reference value. Therefore, depending on whether the first note is higher than a predetermined reference pitch, the singing voice for producing the respective notes can be appropriately determined.

Further, for example, the CPU 201 may execute control such that the first note is the main part, the second note is a harmonic part, and that the harmonic part is sounded smaller than the main part. Therefore, it is possible to make the harmonic part sound so as to complement the main part.

Further, for example, the CPU 201 may execute control such that the first note is the main part, the second is a harmonic part, and the intensity of an effect applied to the harmonic part is smaller than the intensity of the effect applied to the main part. Therefore, it is possible to make the harmonic part sound so as to complement the main part.

Further, according to the present invention, even when a keyboard split function, which is a function that allows playing with different tone colors corresponding to a plurality of pitch ranges (a plurality of pitch ranges set in advance on the keyboard 101), is not used and even if the operations to the keyboard (operations on the first performance operator and the second performance operator) are in the same pitch range, the sound generating section 220 can produce sounds with the singing voices of different singers. This makes it possible to provide an enjoyable performance experience.

It should be noted that the descriptions of the above embodiments are for preferred examples of the information processing device, electronic musical instrument, electronic musical instrument system, sound production control method, and program according to the present invention, and the preset invention is not limited thereto. For example, in the above embodiments, the information processing device of the present invention is described as being included in the electronic musical instrument 2, but the present invention is not limited to this. For example, the functions of the information processing device of the present invention may be implemented by an external device (for example, the above-mentioned terminal device 3 (PC (Personal Computer), tablet terminal, smartphone, etc.) connected to the electronic musical instrument 2 via a wired or wireless communication interface).

Further, in the above embodiments, the trained model 302a and the trained model 302b are described as being included in the terminal device 3, but they may also be included in the electronic musical instrument 2. Then, the trained model 302a and the trained model 302b may infer singing voice information based on the lyrics data and pitch data input to the electronic musical instrument 2. Further, in the above embodiments, a case where the first singer and the second singer are a male singer and a female singer is explained as an example, but the present invention is not limited to this; the first singer and the second singer may be just different singers.

In addition, in the above embodiments, in the case of a chord, the first note is set as the main part and the second note is set as a harmonic part, but the velocity values of the first note and the second note may be compared and the larger one may be set as the main part.

Further, in the above embodiments, a case where the electronic musical instrument 2 is an electronic keyboard instrument has been described as an example, but the electronic musical instrument 2 is not limited to this and may be other electronic musical instruments such as an electronic stringed instrument or an electronic wind instrument.

Further, in the above embodiments, an example is disclosed in which a semiconductor memory such as a ROM or a hard disk is used as a computer-readable medium storing the program according to the present invention, but the present invention is not limited to this example. As other computer-readable media, portable recording media such as SSD and CD-ROM can be applied. Further, a carrier wave is also applied as a medium for providing data of the program according to the present invention via a communication line.

In addition, the detailed configurations and detailed operations of the electronic musical instrument, the information processing device, and the electronic musical instrument system can be changed as appropriate without departing from the spirit of the invention.

Although the embodiments of the present invention have been described above, the technical scope of the present invention is not limited to the above-described embodiments but is determined based on the claims. Furthermore, the technical scope of the present invention includes equivalents in which changes unrelated to the essence of the present invention are made to the subject matter recited in the claims.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. An information processing device configured to be installed in or in communication with an electronic musical instrument having a plurality of performance operators respectively specifying a plurality of pitches, comprising:
a processor that performs the following:
if an operation on a first performance operator among the plurality of performance operators is detected while no operation has been performed on any of the plurality of performance operators, and further if an operation on a second performance operator different from the first performance operator among the plurality of performance operators is detected while the operation on the first performance operator continues, causing the a sound generation section to produce sound of a pitch specified by the first performance operator and sound of a pitch specified by the second performance operator with synthesized singing voices of different singers, respectively.

2. The information processing device according to claim 1,
wherein the synthesized singing voices of the different singers are respectively a synthesized singing voice of a first singer and a synthesized singing voice of a second singer, and
wherein the sound of the pitch specified by the first performance operator is produced with one of the synthesized singing voices of the first singer and the second singer, and the sound of the pitch specified by the second performance operator is produced with another of the synthesized singing voices of the first singer and the second singer.

3. The information processing device according to claim 2, wherein the processor performs the following:
if the operation on second performance operator is detected within a predetermined time after the operation on the first performance operator is detected, comparing the pitch specified by the first performance operator with the pitch specified by the second performance operator, and based on the comparison result, determining which synthesized singing voice to be used among the synthesized singing voices of the first singer and the second singer in producing the sound of the pitch specified by the first performance operator and the sound of the pitch specified by the second performance operator.

4. The information processing device according to claim 2, wherein the processor performs the following:
if the operation on second performance operator is not detected within a predetermined time after the operation on the first performance operator is detected, determining which synthesized singing voice to be used among the synthesized singing voices of the first singer and the second singer in producing the sound of the pitch specified by the first performance operator and the sound of the pitch specified by the second performance operator based on whether or not the pitch specified by the first performance operator is equal to or higher than a predetermined pitch.

5. The information processing device according to claim 1,
wherein the processor designates the singing voice corresponding to the operation of the first performance operator as a main part, and the singing voice corresponding to the operation of the second performance operator as a harmonic part, and
wherein the processor controls the sound generation section so that the harmonic part is produced smaller in volume than the main part.

6. The information processing device according to claim 1,
wherein the processor designates the singing voice corresponding to the operation of the first performance operator as a main part, and the singing voice corresponding to the operation of the second performance operator as a harmonic part, and
wherein the processor controls the sound generation section so that an intensity of an effect applied to the harmonic part is smaller than an intensity of the effect applied to the main part.

7. The information processing device according to claim 1, wherein the first performance operator and the second performance operator are in a same pitch range.

8. An electronic musical instrument, comprising the information processing device as set forth in claim 1 and said plurality of performance operators.

9. An electronic musical instrument system, comprising the information processing device as set forth in claim 1 and said plurality of performance operators in communication with the information processing device.

10. A method performed by a processor configured to be installed in or in communication with an electronic musical instrument having a plurality of performance operators respectively specifying a plurality of pitches, the method comprising:
if an operation on a first performance operator among the plurality of performance operators is detected while no operation has been performed on any of the plurality of performance operators, and further if an operation on a second performance operator different from the first performance operator among the plurality of performance operators is detected while the operation on the first performance operator continues, causing the a sound generation section to produce sound of a pitch specified by the first performance operator and sound of a pitch specified by the second performance operator with synthesized singing voices of different singers, respectively.

11. The method according to claim 10,
wherein the synthesized singing voices of the different singers are respectively a synthesized singing voice of a first singer and a synthesized singing voice of a second singer, and
wherein the sound of the pitch specified by the first performance operator is produced with one of the synthesized singing voices of the first singer and the second singer, and the sound of the pitch specified by the second performance operator is produced with another of the synthesized singing voices of the first singer and the second singer.

12. The method according to claim 11, wherein if the operation on second performance operator is detected within a predetermined time after the operation on the first performance operator is detected, the pitch specified by the first performance operator is compared with the pitch specified by the second performance operator, and based on the comparison result, which synthesized singing voice to be used among the synthesized singing voices of the first singer and the second singer in producing the sound of the pitch specified by the first performance operator and the sound of the pitch specified by the second performance operator is determined.

13. The method according to claim 11, wherein if the operation on second performance operator is not detected within a predetermined time after the operation on the first performance operator is detected, which synthesized singing voice to be used among the synthesized singing voices of the first singer and the second singer in producing the sound of the pitch specified by the first performance operator and the sound of the pitch specified by the second performance operator is determined based on whether or not the pitch specified by the first performance operator is equal to or higher than a predetermined pitch.

14. The method according to claim 10,
wherein the singing voice corresponding to the operation of the first performance operator is designated as a main part, and the singing voice corresponding to the operation of the second performance operator is designated as a harmonic part, and
wherein the sound generation section is controlled so that the harmonic part is produced smaller in volume than the main part.

15. The method according to claim 10,
wherein the singing voice corresponding to the operation of the first performance operator is designated as a main part, and the singing voice corresponding to the operation of the second performance operator is designated as a harmonic part, and
wherein the sound generation section is controlled so that an intensity of an effect applied to the harmonic part is smaller than an intensity of the effect applied to the main part.

16. The method according to claim 10, wherein the first performance operator and the second performance operator are in a same pitch range.

17. A non-transitory computer readable storage medium storing instructions executable by a processor that is configured to be installed in or in communication with an electronic musical instrument having a plurality of performance operators respectively specifying a plurality of pitches, the instruction causing the processor to perform the following:
if an operation on a first performance operator among the plurality of performance operators is detected while no operation has been performed on any of the plurality of performance operators, and further if an operation on a second performance operator different from the first performance operator among the plurality of performance operators is detected while the operation on the first performance operator continues, causing the a sound generation section to produce sound of a pitch specified by the first performance operator and sound of a pitch specified by the second performance operator with synthesized singing voices of different singers, respectively.
